(19) United States
(12) Patent Application Publication
(10) Pub. No.: US 2007/0284485 A1
(43) Pub. Date: Dec. 13, 2007

(54) VIBRATION ABSORBING CLAMP FOR ELONGATED OBJECTS AND METHOD OF MANUFACTURING THE SAME

(75) Inventor: Hiroyuki Kato, Utsunomiza-shi (JP)

Correspondence Address: MILES & STOCKBRIDGE PC, 1751 PINNACLE DRIVE, SUITE 500, MCLEAN, VA, 22102-3833, US

(73) Assignee: Newfrey LLC

(21) Appl. No.: 11/761,737

(22) Filed: Jun. 12, 2007

(30) Foreign Application Priority Data
Jun. 12, 2006 (JP) 2006-162452

(51) Int. Cl. F16L 3/22

(52) U.S. Cl. 248/68.1

(57) ABSTRACT

A vibration absorbing clamp for holding elongated members has an anchor and a holder that are coupled to one another through vibration absorbing material and cooperable coupling members embedded in the vibration absorbing material. The coupling members are free of direct contact with one another but serve to limit relative movement between the holder and the anchor. The clamp can be manufactured in a two-stage molding process in which the holder and the anchor, with the coupling members, are first molded of hard plastic, and then the vibration absorbing material is molded into a space between the holder and the anchor so as to embed the coupling members.

### CROSS-REFERENCE TO RELATED APPLICATION

This application claims the benefit of Japanese Patent Application 2006-162452 filed on Jun. 12, 2006, incorporated herein by reference.

### BACKGROUND OF THE INVENTION

This invention relates to a clamp for mounting elongated objects, such as a pipe, on a workpiece, such as a vehicle body, and that reduces or prevents vibration transmission between elongated objects and a workpiece. The invention also relates to a method of manufacturing such clamps.

Vibration absorbing clamps for mounting elongated objects on a workpiece, such as a vehicle body, are well known. See, for example, Japanese Patent Laid-Open Publication 09-250517A (Patent Document 1); Japanese Patent Laid-Open Publication No. 2001-343006A (Patent Document 2); and Japanese Patent Laid-Open Publication No. 2001-343089A (Patent Document 3).

Each of the Patent Documents discloses a vibration absorbing clamp for elongated objects in which a holder for an elongated object is formed of hard plastic, and vibration absorbing material is utilized to reduce or prevent transmission of vibrations to or from the elongated objects.

In the clamp of Patent Document 1, a holder is connected to a body panel by a metal segment and a stud bolt. Vibration absorbing material is provided between the holder and the metal segment and between the metal segment and the body panel, but the metal segment has no vibration absorbing function.

In the clamp of Patent Document 2, the vibration absorption material is interposed between a holder and a base to be mounted on a workpiece. However, the holder and the base are separate parts spaced apart in their entirety. If a force is applied tending to move the holder in a direction longitudinally of an elongated object, the holder is likely to be decoupled from the base.

In the clamp of Patent Document 3, vibration absorbing material surrounds an entire outer peripheral surface of an elongated member in a holder, but the holder and an anchor are spaced apart in their entirety. This clamp suffers from the same problem as the clamp of Patent Document 2.

### BRIEF DESCRIPTION OF THE INVENTION

The present invention provides an improved vibration absorbing clamp constructed to overcome problems of prior vibration absorbing clamps, and provides a method of manufacturing the improved clamps.

In an embodiment of the invention, a vibration absorbing clamp comprises a holder for receiving and holding one or more elongated objects and an anchor for mounting the clamp on a workpiece. The anchor may have a stud-engaging portion and one or more additional receivers for elongated objects. The holder and the anchor have cooperable coupling members in a space between the holder and the anchor that is filled with vibration absorbing material that embeds the coupling members. The holder and the anchor are connected to one another by the vibration absorbing material. The coupling members limit relative movement between the holder and the anchor without direct contact of the coupling members to one another, and prevent decoupling of the anchor and the holder.

### BRIEF DESCRIPTION OF THE DRAWINGS

The invention will be further described in conjunction with the accompanying drawings, which illustrate a preferred (best mode) embodiment, and wherein:

FIG. 1 is a top plan view of a clamp before a vibration absorbing material is filled therein, according to one embodiment of the present invention.

FIG. 2 is a front view of the clamp in FIG. 1.

FIG. 3 is a bottom view of the clamp in FIG. 2.

FIG. 4 is a left side view of the clamp in FIG. 2.

FIG. 5 is a right side view of the clamp in FIG. 2.

FIG. 6 is a sectional view of the clamp taken along the line A-A in FIG. 1.

FIG. 7 is a sectional view of the clamp taken along the line B-B in FIG. 2.

FIG. 8 is a top plan view of an anchor of the clamp in FIG. 1.

FIG. 9 is a front view of the anchor in FIG. 8.

FIG. 10 is a bottom view of the anchor in FIG. 9.

FIG. 11 is a right side view of the anchor in FIG. 9.

FIG. 12 is a top plan view of an elongated object holder of the clamp in FIG. 1.

FIG. 13 is a front view of the holder in FIG. 12.

FIG. 14 is a bottom view of the holder in FIG. 13.

FIG. 15 is a left side view of the holder in FIG. 13.

FIG. 16 is a top plan view of a vibration absorbing clamp after the vibration absorbing material has been filled therein, according to the embodiment of the present invention.

FIG. 17 is a front view of the vibration absorbing clamp in FIG. 16.

FIG. 18 is a bottom view of the vibration absorbing clamp in FIG. 16.

FIG. 19 is a sectional view of the vibration absorbing clamp taken along the line C-C in FIG. 16.

FIG. 20 is a sectional view of the vibration absorbing clamp taken along the line D-D in FIG. 17.

FIG. 21 is a front view of the vibration absorbing clamp in FIG. 17, which mounts a plurality of elongated objects on a workpiece.

### DETAILED DESCRIPTION OF THE INVENTION

The drawings illustrate one embodiment of a vibration absorbing clamp by which one or more elongated objects, such as pipes, tubes, or wire harnesses, can be mounted on a workpiece, such as a vehicle body panel. The clamp comprises an anchor 2 and a holder 3. The anchor 2 is used to mount the clamp on the workpiece, and the holder 3 is used to receive and hold one or more elongated objects. The anchor and the holder are coupled to one another via vibration absorbing material, and relative movement between the anchor and the holder is limited by cooperable coupling members which are not in direct contact with one another.

In the embodiment, the anchor and the holder are made of a hard plastic (resin) and are preferably prepared together by a single molding process using a die assembly equipped with a slide mechanism. The cooperable coupling members are formed and situated in the single molding process. The vibration absorbing material may comprise a softer plastic (resin) including an elastomer, which is filled in between opposed walls of the anchor and the holder by a so-called two-color molding process or an insert molding process.

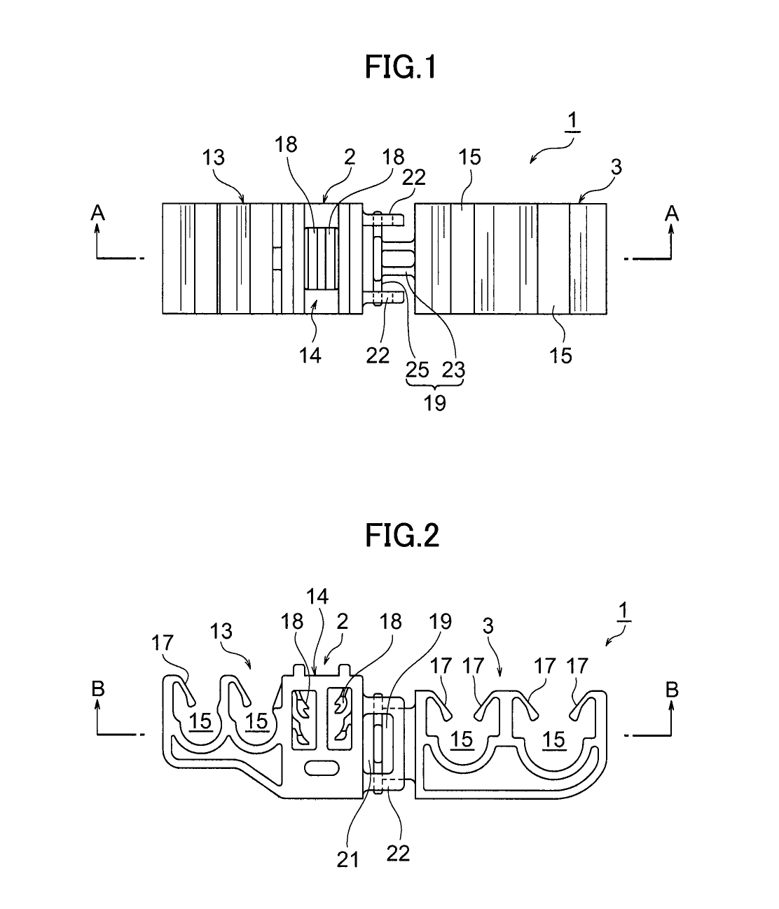

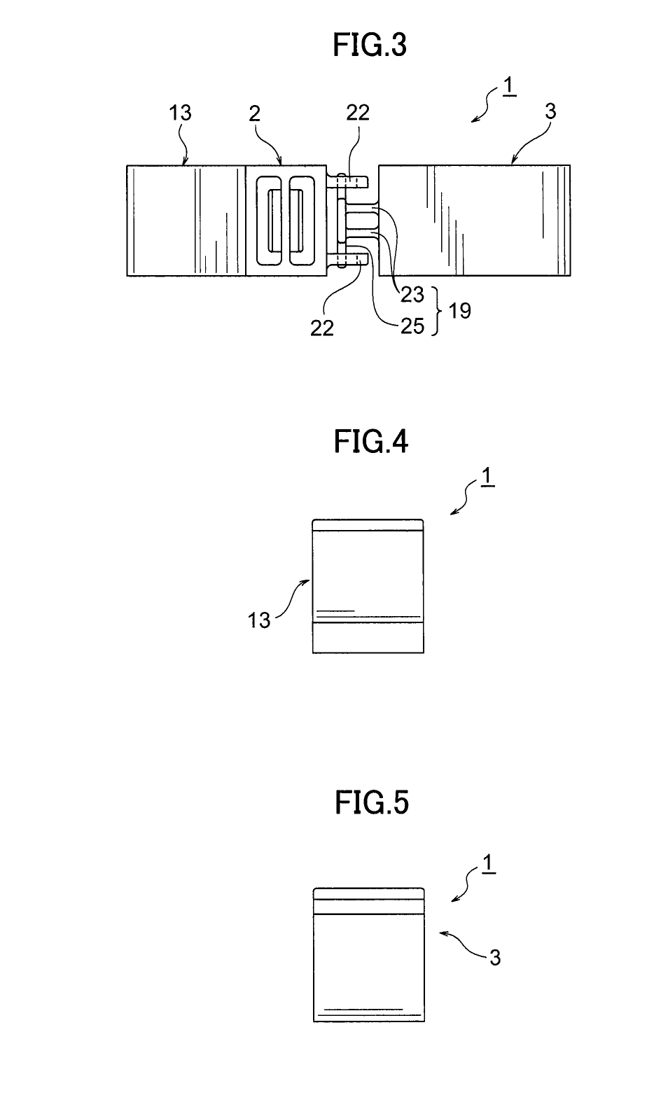

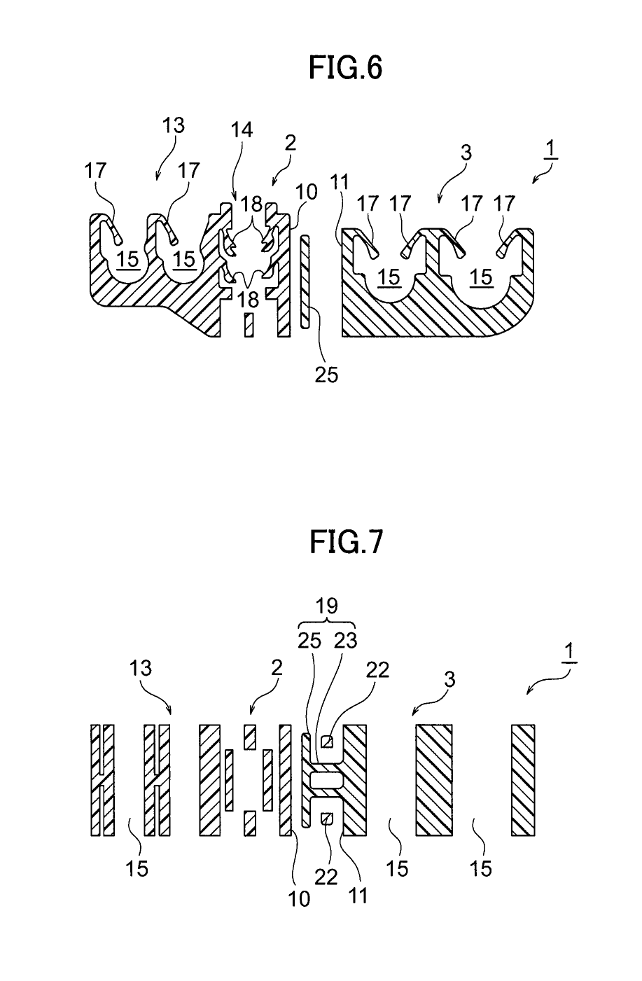

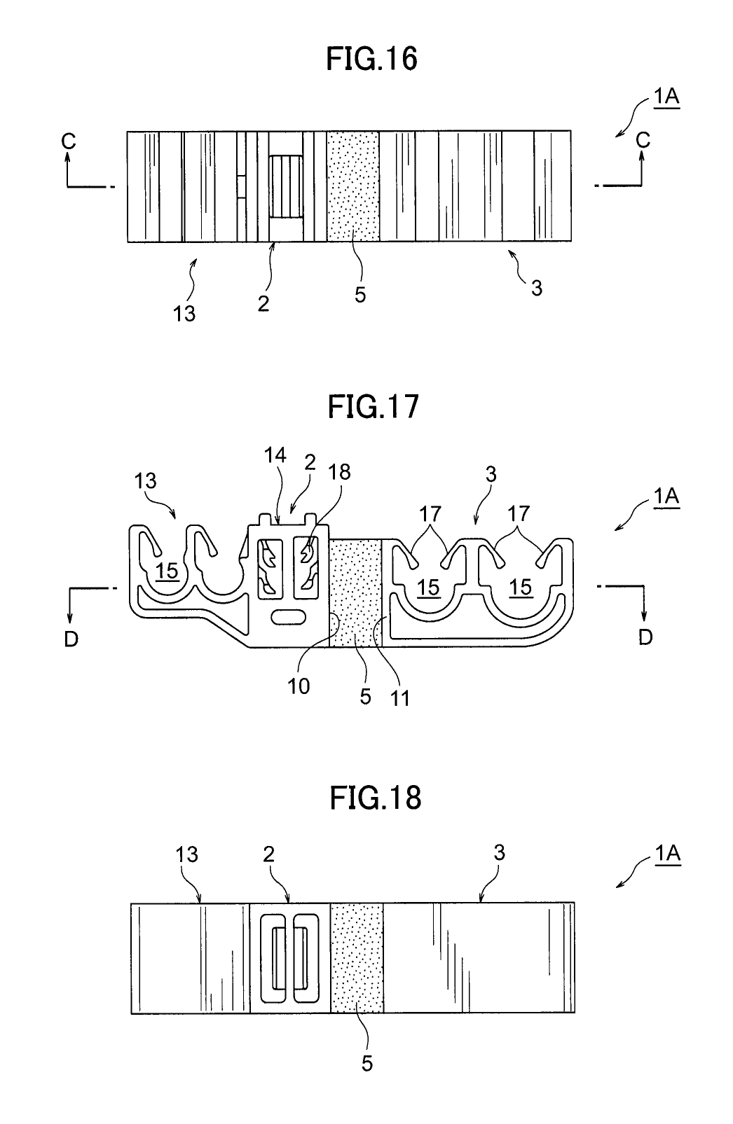

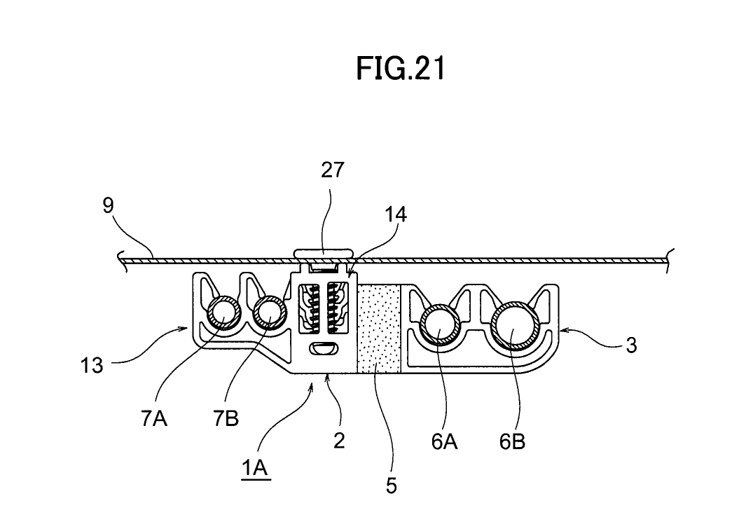

FIGS. 1-15 illustrate an initial molded product (initial clamp 1 ) and parts thereof prior to the addition of the vibration absorbing material. FIGS. 16-18 illustrate a final molded product (final clamp 1A) after the addition of vibration absorbing material. FIG. 21 shows the final vibration absorbing clamp 1A attached to a workpiece.

Referring to FIGS. 1-15, the initial clamp 1 comprises the anchor 2 adapted to be fixed to a workpiece, such as a vehicle body panel, and the holder 3 adapted to receive and hold elongated objects. The anchor 2 and the holder 3 are separate components that are coupled to one another.

The anchor 2 and the holder 3 have opposed substantially parallel walls 10 and 11 in face-to-face relation to one another, with a given distance therebetween defining a space between the opposed walls. As later described in detail, cooperable coupling members extend from the respective opposed walls, cooperate to limit relative movement between the anchor 2 and the holder 3, and prevent decoupling of the anchor 2 and the holder 3 from one another.

In the embodiment, the anchor 2 has a stud-engaging portion 14 for receiving a stud fixed to a workpiece, whereby a clamp of the invention can be mounted on a workpiece. In the form shown, the stud-engaging portion 14 has resilient pawls 18 to grip a stud, as later described. The invention is not limited to the use of a stud, however. For example, an anchor-leg-shaped clip integral with the anchor 2 may be inserted into a mounting hole of a workpiece and engaged with a peripheral edge of the mounting hole, as is well known.

The holder 3 has a plurality of receivers 15 for receiving and holding elongated objects, and the anchor 2 has additional receivers 15 for elongated objects in a receiving portion 13. The number of receivers and their size may vary according to the needs of a particular application of the clamp. Of course, the anchor 2 need not have receivers for elongated objects and may merely be used to attach a vibration absorbing clamp of the invention to a workpiece.

The receivers 15 have resilient wings 17 which flex to allow entry of the elongated objects into the receivers 15 and then return to an initial position to hold the objects in place in the receivers. Each resilient wing 17 may be formed as a plate-shaped member extending obliquely downward from a top end toward a curved inner bottom surface of a receiver 15 and having a distal end adapted to come into contact with an outer peripheral surface of an elongated member in a receiver.

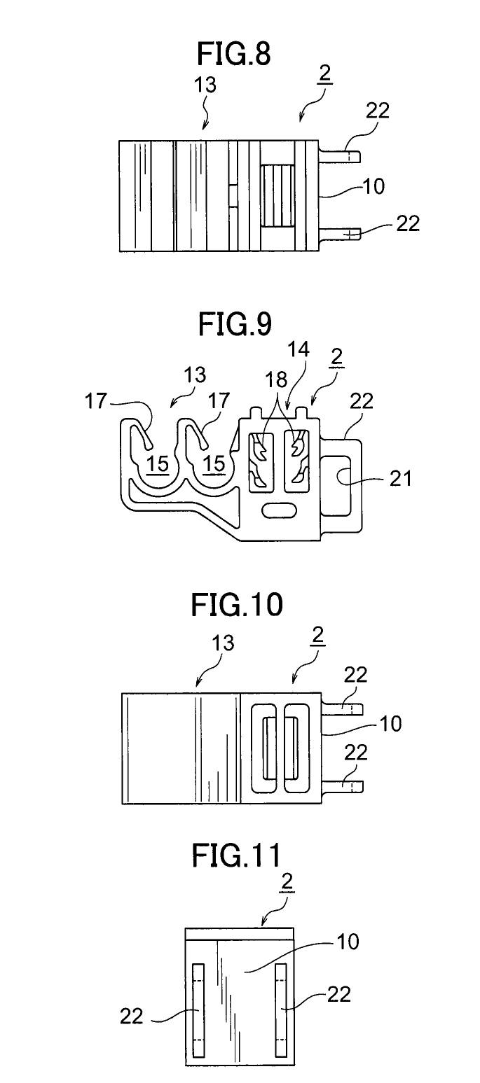

The anchor 2 and the holder 3 of the initial clamp 1 have cooperable coupling members 19 and 22 which extend integrally from surfaces of the respective opposed walls 10 and 11. One of the coupling members includes a pair of substantially parallel arms 22 extending from the wall 10, as shown in FIGS. 8-11. Each arm has an opening 21 and is substantially C-shaped in the embodiment.

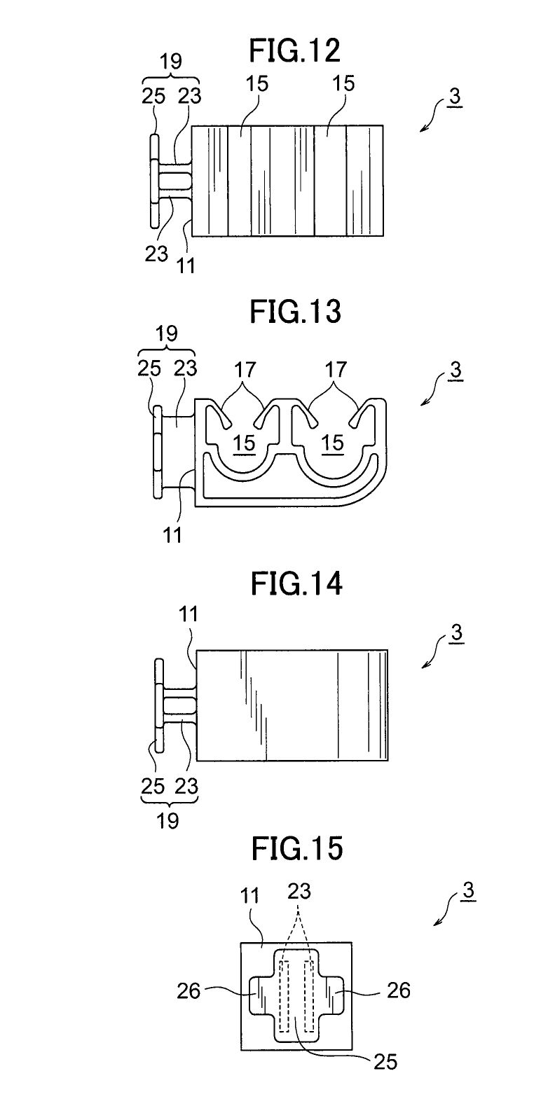

The other coupling member, 19, comprises plates 23 and 25. See FIGS. 12-15. Plate 25 is supported by parallel plates 23 extending integrally from wall 11 and is substantially parallel to wall 11. In the embodiment, plate 25 has a cruciform shape with projections 26 extending from one pair opposite edges of the plate and similar projections extending perpendicular to projections 26 from another pair of opposite edges of the plate. Projections 26 enter openings 21 in arms 22. The other projections of plate 25 are disposed between associated parts of the arms 22. The openings 21 are formed in a size and configuration adapted to receive projections 26 of the plate 25 therein in a non-contact arrangement relative to the respective arms. The shape of the plate 25 and its relationship to the arms 22 is designed to prevent the projections 26 of the plate 25 from getting out of the openings 21 in directions parallel to the walls 10 and 11 as well as perpendicular thereto. Other configurations of cooperable coupling members which have these same functions may be used.

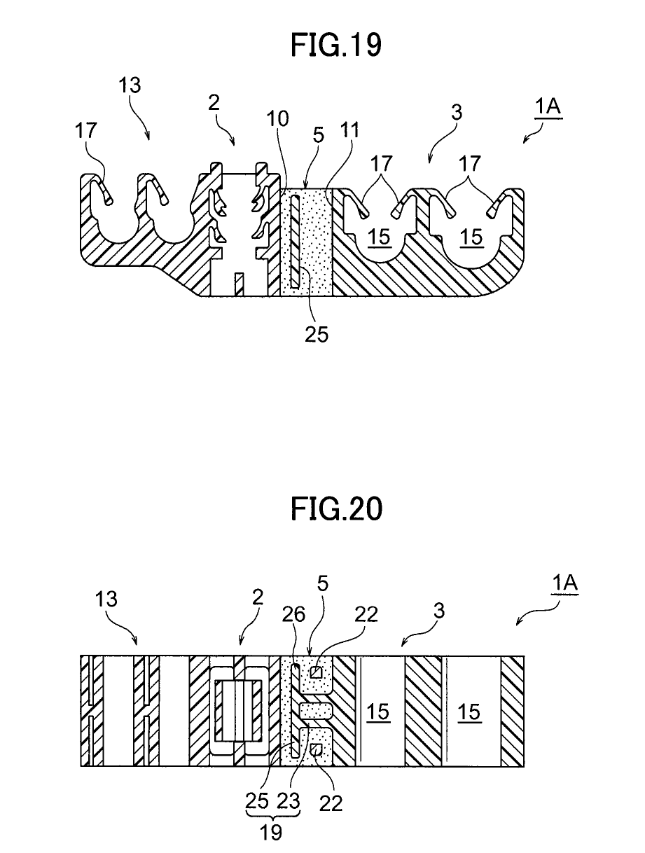

In the process of molding the anchor 2 and the holder 3, the cooperable coupling members 19 and 22 are disposed as shown in FIGS. 1-3, so that they are mutually engaged without contacting one another. In order to complete the vibration absorbing clamp of the invention, the final clamp 1A is formed as shown in FIGS. 16-20, by filling the space between opposed walls 10 and 11 with vibration absorbing material 5, whereby the cooperable coupling members 19 and 22 are embedded in the vibration absorbing material 5, as shown in FIGS. 19 and 20.

In the invention, the anchor 2 and the holder 3 are connected via the vibration absorbing material 5. There is no vibration transmitting direct contact between the cooperable coupling members 19 and 22. The coupling members limit relative movement between the anchor 2 and the holder 3 along directions parallel to the walls 10 and 11 and along a direction perpendicular to walls 10 and 11. Decoupling of the holder 3 from the anchor 2 is prevented by the cooperable coupling members 19 and 22. Movement of one of the coupling members relative to the other is opposed by the intervening vibration absorbing material 5, which compresses to limit such movement.

FIG. 21 shows a vibration absorbing clamp 1A of the invention attached to a workpiece 9, such as a vehicle body panel, while holding two pipes 6A and 6B and 7A and 7B. The pipes may be fuel pipes and/or brake fluid pipes, for example. A stud 27, such as a stud bolt, is fixed to the workpiece 9 and enters an opening at one end of the stud-engaging portion 14. Threads or grooves of the stud are engaged by the pawls 18 described earlier, to prevent the stud from backing out of the stud-engaging portion 14.

By virtue of the invention almost no vibration is transmitted between the workpiece 9 and the elongated objects 6A and 6B held by the holder 3. This is not the case with regard to the elongated objects 7A and 7B, but it is presumed that in the application of the invention shown in FIG. 21 vibration transmission between these objects and the workpiece 9 is not a matter of concern.

While a preferred embodiment of the invention has been shown and described, changes can be made without departing from the principles and spirit of the invention, the scope of which is defined in the accompanying claims.

What is claimed is:

1. A vibration absorbing clamp comprising:
a holder with a receiver for an elongated object; and
an anchor for mounting the holder on a workpiece,
wherein the holder and the anchor are coupled to one another via a vibration absorbing material in a space between opposed surfaces of the holder and the anchor,
wherein the holder and the anchor have respective cooperable coupling members embedded in the vibration absorbing material and free of direct contact with one another, and
wherein the coupling members are constructed to limit relative movement between the holder and the anchor.

2. A vibration absorbing clamp according to claim 1, wherein the cooperable coupling members are constructed to restrict relative movement of the holder and the anchor along orthogonal directions.

3. A vibration absorbing clamp according to claim 2, wherein the orthogonal directions include directions parallel to the opposed surfaces and a direction perpendicular to the opposed surfaces.

4. A vibration absorbing clamp according to claim 3, wherein the opposed surfaces are surfaces of substantially parallel walls.

5. A vibration absorbing clamp according to claim 4, wherein the coupling members include a pair of substantially parallel arms extending from one of the walls and having openings therein and a plate mounted on the other wall substantially parallel thereto and having a first pair of projections extending into the respective openings and a second pair of projections between the respective arms.

6. A vibration absorbing clamp according to claim 5, wherein the arms are C-shaped and the projections are arranged in a cruciform configuration.

7. A vibration absorbing clamp according to claim 1, wherein the anchor has a stud-engaging portion for receiving and holding a stud projecting from a workpiece, whereby the clamp is mounted on the workpiece.

8. A vibration absorbing clamp according to claim 1, wherein the clamp has an additional receiver for an elongated object, that is integral with the anchor.

9. A method of manufacturing a vibration absorbing clamp, comprising:
molding from hard plastic an elongated object holder and an anchor for mounting a clamp on a workpiece, in a manner that provides cooperable coupling members between the holder and the anchor that are mutually engaged, without direct physical contact with one another, in a space between surfaces of the holder and the anchor; and
embedding the coupling members in a vibration absorbing material in the space so as to connect the holder and the anchor via the vibration absorbing material.

10. A method according to claim 9, wherein the vibration absorbing material is molded into a space between opposed surfaces of the holder and the anchor where the coupling members are located.

11. A method according to claim 9, wherein the coupling members are formed to provide a pair of spaced substantially parallel arms extending from one of the opposed surfaces and a plate supported on the other opposed surface substantially parallel thereto, the plate having oppositely directed projections extending into openings of respective arms and having oppositely directed projections between the arms.
